(19) United States
(12) Patent Application Publication
(10) Pub. No.: US 2019/0321835 A1
(43) Pub. Date: Oct. 24, 2019

(54) LIGATURE RESISTANT SHOWERHEAD

(71) Applicant: Acorn Engineering Company, City of Industry, CA (US)

(72) Inventor: Darryl M. Boeltl, Whittier, CA (US)

(21) Appl. No.: 16/388,034

(22) Filed: Apr. 18, 2019

Related U.S. Application Data
(60) Provisional application No. 62/659,446, filed on Apr. 18, 2018.

(51) Int. Cl. B05B 1/18; B05B 15/68

(52) U.S. Cl. CPC B05B 1/18; B05B 15/68

(57) ABSTRACT

A ligature resistant showerhead including a housing of a shape resistant to the attachment of a ligature. Portions of the housing define a water passageway with an inlet end and an outlet end. A water directing component is received and retained in the outlet end of the housing. The water directing component includes an outlet spout, which is moveable between a various angular positions relative to the outlet axis. Through a frictional engagement, the outlet spout is selectively retained in one of multiple angular positions, but is moveable between other angular positions by a force manually applied to the outlet spout.

### BACKGROUND

### 1. Field of the Invention

The present invention generally relates to a bathroom showerhead fixture. More specifically, the invention relates to a showerhead fixture that is resistant to the attachment of a ligature.

### 2. Description of Related Art

Mental health and other institutions have a continuing concern regarding suicide by institutionalized individuals. Statistics show that, annually, there are approximately 1800 suicides by institutionalized individuals and that 75% of these suicides occur in the individual's bathroom, bedroom or closet. One suicide method involves the fastening of a ligature to an object in the room.

In the interest of the well-being of institutionalized individuals, various institutions are desirous of incorporating fixtures within their facilities that discourage the formation of an anchor point for a ligature. Such structures are typically referred to as being ligature resistant.

To prevent a fixture from being used as an anchor point for securing a ligature, the intent is to design the fixture so that it does not allow for a ligature to be pulled on while being retained on the fixture. Rather, when a ligature is wrapped around a portion of the fixture, pulling on the ligature, in substantially any direction, will cause the ligature to pull or slip off of the fixture. When designing such a fixture, the exterior of the fixture is typically devoid of adjacent surfaces forming angles or corners that allow for retention of the ligature. Instead, the exterior surfaces of the fixture are often sloped or angled in the direction of the water outlet of the fixture.

As a result, ligature resistant water dispensing fixtures, such as showerheads, have fixed position nozzles. Accordingly, the spray of water from the fixture is directed at a fixed angle relative to the end-user, which may not be satisfactory for proper showering or bathing.

### SUMMARY OF THE INVENTION

In view of the limitations and drawbacks of the known technology, the present invention provides a ligature resistant showerhead having a spray angle that is adjustable by the end-user.

Accordingly, as an aspect of the invention, a ligature resistant showerhead is provided. The showerhead includes a housing having an exterior shape resistant to the attachment of a ligature. Portions of the housing define a water passageway with an inlet end and an outlet end, the outlet end of which may include includes portions defining an enlarged diameter recess about an outlet axis. A water directing component is received and retained in the housing. The water directing component includes a nozzle having an outlet spout that is moveable between a plurality of angular positions relative to the outlet axis and defines different spray angles of the showerhead. A portion of the water directing component frictionally engages the nozzle whereby the outlet spout is selectively retained in one of the angular positions, but is moveable between other angular positions by a force manually applied to the nozzle.

In another aspect of the invention, a biasing member is coupled to and applies a biasing force against the water directing component.

In a further aspect, the biasing member is positioned between the housing and the water directing component.

In an additional aspect of the invention, the biasing member is positioned within the recess.

In yet another aspect, the biasing member is an O-ring.

In a further aspect of the invention, the biasing member is located in the recess and positioned in between the housing and one of the ball cups.

In an additional aspect, the biasing member is an O-ring.

In still another aspect of the invention, the friction member is an O-ring

In yet a further aspect, the water directing component includes two friction members.

In an additional aspect of the inventions, the two friction members are O-rings.

In another aspect, the nozzle includes a spherical body from which the outlet spout extends.

In still a further aspect of the invention, the water directing component further includes a pair of ball cups enclosing the spherical body.

In yet an additional aspect, a friction member is positioned between at least one of the ball cups and the spherical body.

In another aspect of the invention, the outlet end of the passageway is oriented at an angle relative to the inlet end of the passageway.

In a further aspect of the invention, the housing includes a base wall oriented perpendicular to the inlet end of the passageway, the inlet end of the passageway being offset from a center of the base wall.

In an additional aspect of the invention, the housing is conical.

In yet another aspect, the housing tapers from a base wall to an apex, the inlet end of the passageway being located toward the base wall and the outlet end of the passage being located toward the apex.

In still a further aspect of the invention, the housing defines a length from a base wall to an apex and progressively reduces in effective diameter over the length.

In an additional aspect, the housing defines a length and progressively reduces in width over the length.

In another aspect of the invention, the housing includes exterior surfaces extending from a base wall to a distal end, and all of the exterior surfaces of the housing having a decreasing slope in a direction proceeding from the base wall to the distal end.

Further objects, features and advantages of this invention will become readily apparent to persons skilled in the art after review of the following description, including the claims, with reference to the drawings that are appended to and form a part of this specification.

### BRIEF DESCRIPTION OF THE DRAWINGS

FIG. 1 is a cross-sectional view of a showerhead fixture embodying the principles of the present invention.

FIG. 2 is a cross-sectional view, similar to FIG. 1, with the housing and water directing components of the showerhead fixture shown in an exploded view.

FIG. 3 is a further exploded view of the water directing component seen in FIG. 2.

FIG. 4A is a cross-sectional and perspective view of another showerhead fixture embodying the principles of the present invention, with the water directing component omitted therefrom.

FIG. 4B is a plan view of the showerhead fixture seen in FIG. 4A.

FIG. 4C is a cross-sectional view of the showerhead fixture seen in FIGS. 4A and 4B.

FIG. 4D is a perspective view of the showerhead fixture seen in FIGS. 4A-C generally taken from below the showerhead fixture in the installed position.

FIG. 4E is a perspective view of the showerhead fixture seen in FIGS. 4A-C generally taken from above the showerhead fixture in the installed position.

### DETAILED DESCRIPTION

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part whether or not such an access is designated in the figures. An axial surface is therefore one that faces in the axial direction. In other words, an axial surface faces in a direction along the central axis. A radial surface therefore faces radially, generally away from or toward the central axis.

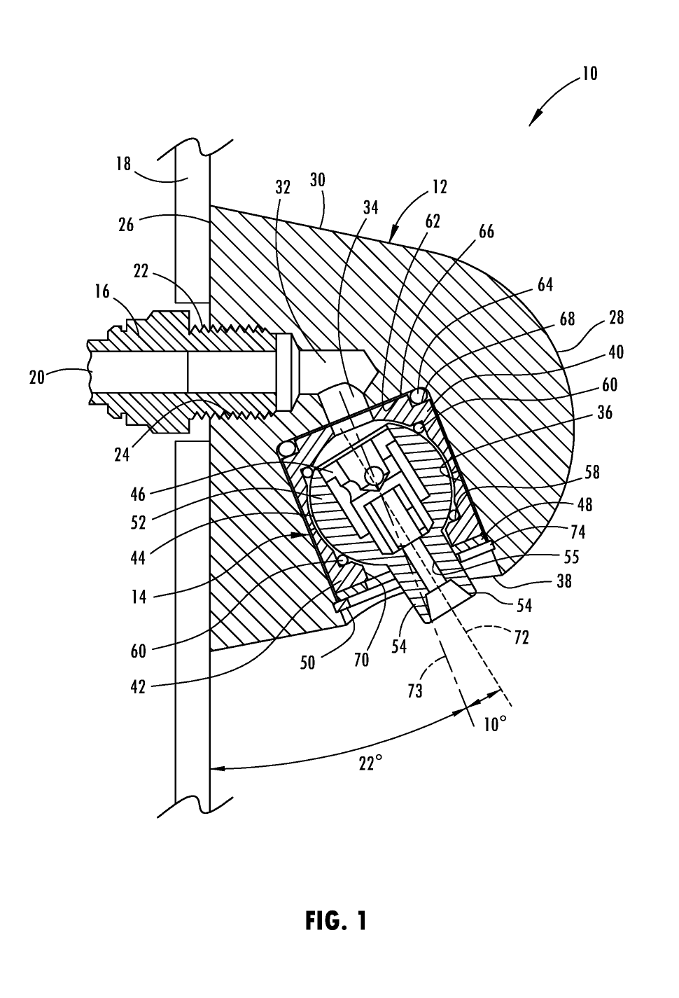

Referring now to the drawings, a showerhead embodying the principles of the present invention is generally illustrated in FIG. 1 and designated at 10. The showerhead 10 includes as its principal components a housing 12 and a water directing component 14, which, in the present disclosure, is in the form of a cartridge. Generally, the housing 12 has an exterior shape that facilitates resistance to the attachment of a ligature. In this regard, the exterior surfaces of the housing 12 exhibits a shape that will facilitate the slipping or pulling off of the ligature from the fixture if a pulling force is applied to the ligature in substantially any direction. The housing 12 is configured to mount to a spigot 16 of the water supply system and which extends through a wall 18 of the room or facility where the showerhead 10 is installed. The cartridge 14 is received in the housing 12 and is in fluid communication with the spigot 16 by way of a passageway 20 defined in the housing 12. Upon water being provided by the water supply system to the spigot 16, the water is transferred via the passageway 20 to the cartridge 14 where it is discharged from the showerhead 10. Cartridge 14 is such that the direction of the spray from the showerhead 10 can be adjusted by the end-user.

As seen in FIG. 1, the terminal end of the spigot 16, the end of the spigot 16 is provided with external threads 22. The external threads 22 mate with a corresponding internally threaded bore 24 defined through the housing 12 as a first portion of the passageway 20. In the illustrated construction, the housing 12 has a monolithic construction. However, the construction of the housing 12 is not required to be monolithic.

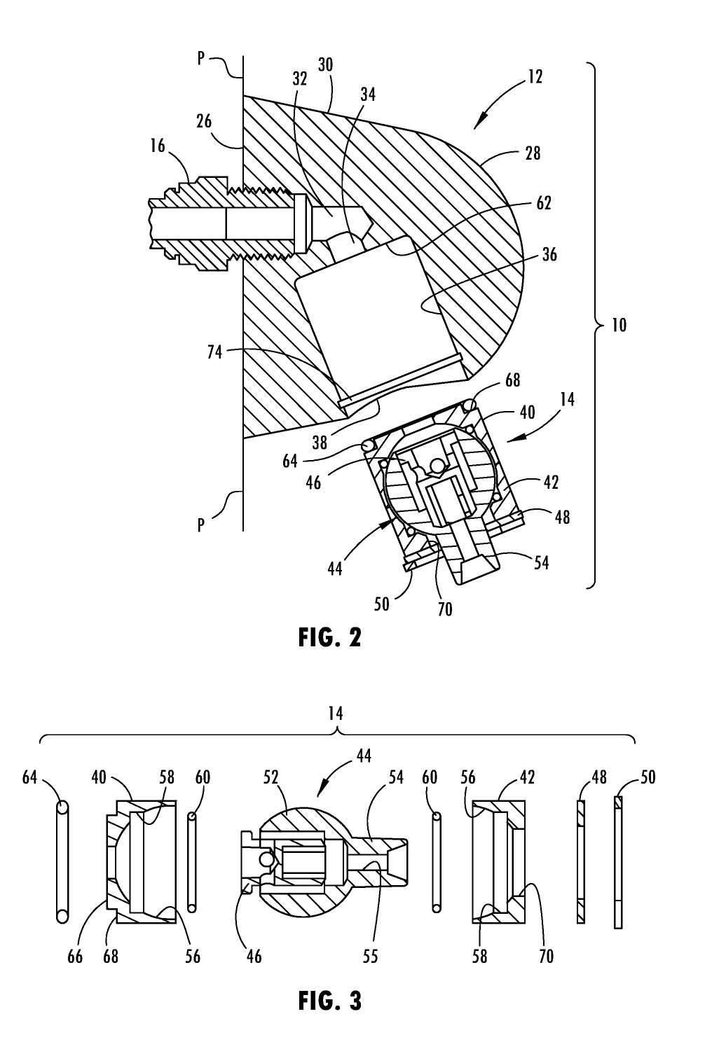

In one non-limiting implementation, the housing 12 has a round, conical presentation that narrows as it extends away from the wall 18. As such, the housing includes a base wall 26 adjacent to the wall 18 and extends to a rounded or blunt nosed apex 28, which is spaced apart from the wall 18. As seen in FIGS. 1 and 2, between the apex 28 and the flat base wall 26, the housing 12 is provided with a smooth, round conical sidewall 30 tapering from the base wall 26 to the apex 28.

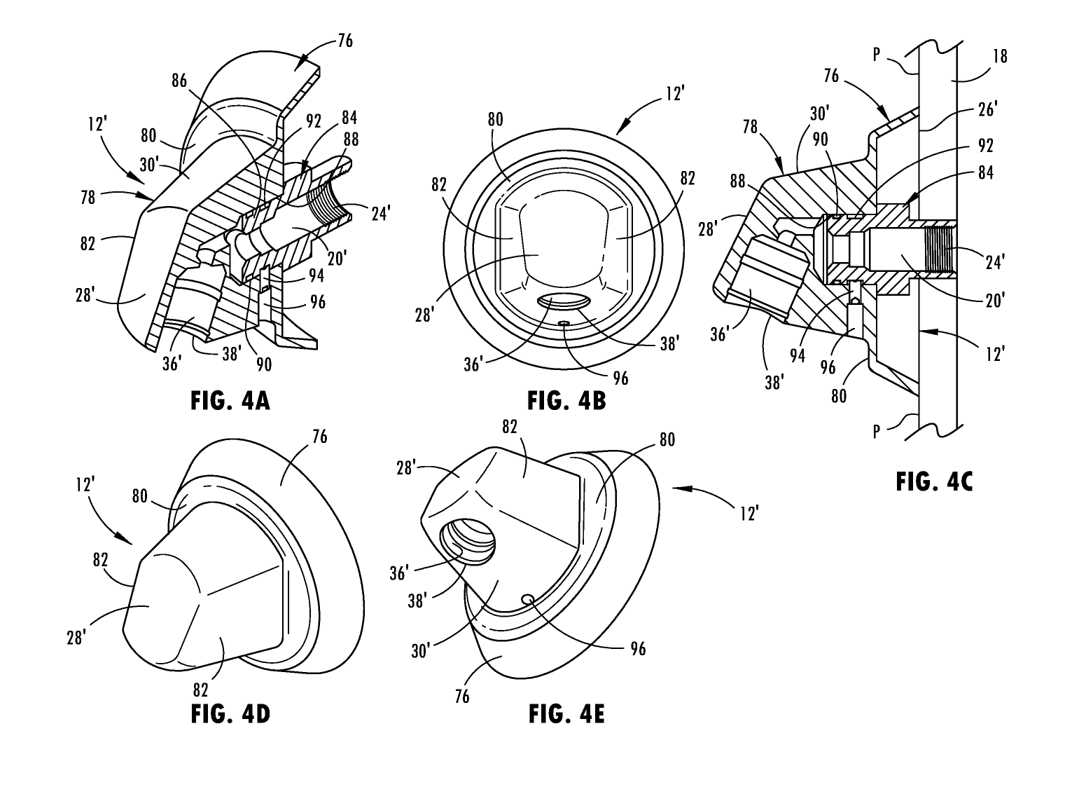

While illustrated with the apex 28 as a blunt nose, the shape of the end of the conical presentation need not be specifically provided with as a blunt nose, nor need the sides of the housing 12 be formed as a right cone, as seen in those figures. Rather, the sides of the housing may incorporate flat, round or curved surfaces, in one or both of the longitudinal and circumferential directions, and the end of the housing may be rounded, flat, multifaceted or provided with a different shape. Multiple configurations are possible so long as the shape and overall design promotes resistance to the attachment of a ligature. One such alternative construction for the housing is seen in FIG. 4A-4E, which is discussed below.

Referring back to FIGS. 1 and 2, the internally threaded bore 24 extends into the housing 12 from the base wall 26 and is oriented generally perpendicularly to the plane P defined by the surface of the base wall 26. Preferably, but not necessarily, the bore 24 is offset from the center of the base wall and positioned in an upper half of the housing 12 when the showerhead 10 is fully mounted and installed on the spigot 16. Providing the bore 24 in this manner enables the overall showerhead to be smaller in size while still providing sufficient room for accommodating the cartridge 14 in the housing.

When mounting the showerhead 10 to the spigot 16, the external threads 22 of the spigot 16 are first wrapped with thread tape, typically a tape or film made of polytetrafluoroethylene. Alternatively, an O-ring connection may be provided to facilitate a fluid tight seal between the spigot 16 and the showerhead 10. When the housing 12 is engaged with the spigot 16 and threaded onto the external threads 22, the thread tape, not illustrated in the figures, remains between the external and internal threads 22, 24 creating a fluid tight seal between the spigot 16 and the housing 12.

As mentioned, the shape of the showerhead 10 is configured to be ligature resistant; the overall shape of the showerhead 10 resists, inhibits or otherwise prevents securing or attaching of a ligature to the showerhead 10. In other words, the shape of the showerhead 10 is such that substantially any attempt to secure a ligature about the showerhead 10 will result in the ligature being pulled off of the showerhead 10 upon the application of a force to the ligature. Nothing in the illustrated embodiments provides a feature upon which the ligature can catch and be retained.

While the present showerhead 10 is described as being ligature resistant, it is important to note that no such labeled device or fixture can guarantee that an individual intent on securing a ligature could not devise or modify the fixture in such a way that a ligature could be attached thereto. Ligature “proof” is a goal to be sought, but is not asserted as being presented herein.

After the internally threaded bore 24, the passageway 20 proceeds coaxially therewith reducing in diameter to a bore 32 approximately equal in diameter to the internal diameter of the spigot 16. This reduced diameter bore 32 is intersected with an angled bore 34, which preferably has the same diameter. The intersection of the reduced diameter bore 32 and the angle bore 34 is generally at an angle of about 22° relative to the plane of the base wall 26, but need not be limited to this specific angularity. Finally, the passageway 20 proceeds coaxially from angled portion 34 toward the conical sidewall 30 via an enlarged diameter bore 36. The enlarged diameter bore 36 thus defines the exit opening 38 of the passageway 20. As seen in FIG. 1, the exit opening 38 is principally defined in the conical sidewall 30 and partially defined in the transition to the apex 28 of the housing 12. Alternatively, the exit opening 38 could be defined exclusively in the conical sidewall 30 or to a greater extent than shown in the transition to the apex 20.

Retainingly received within the enlarged diameter portion 36 is the cartridge 14 mentioned above. The cartridge 14 is principally composed of a pair of ball cups 40, 42, a pivotable nozzle 44, a pattern insert 46, an orifice plate 48 and a locking ring 50.

The nozzle 44 includes a spherical body 52 with an outlet spout 54 extending therefrom. Accordingly, a discharge bore 55 extends through both the spherical body 52 and the outlet spout 54 of the nozzle 44. In the spherical body 52, the discharge bore 55 receives the pattern insert 46. During the flow of water through the showerhead 10, the pattern insert 46 causes the water to spin about the axis of the discharge bore 55. This spinning of the water results in the water exiting the outlet spout 54 and discharge bore 55 with a predetermined cone shape. As such, the shape of discharged stream of water is at least partially defined by the pattern insert 46. To those skilled in the relevant technological field, pattern inserts are well known devices and further description regarding the construction and operation thereof is not required or included herein.

Internally, each of the ball cups 40, 42 is provided with a hemispherical, concave surface 56 generally corresponding to the shape of the spherical body 52. Once assembled, the spherical body 52 is received and retained between the inner and outer ball cups 40, 42, which operate to define a socket for the spherical body 52 of the nozzle 44. Each of the concave surfaces 56 further includes an annular groove 58 in which an O-ring 60 is received. When fully installed, the O-rings 60 not only define seals between the spherical body 52 and the ball cups 40, 42, but also frictionally engage the spherical portion 52 with a force sufficient to retain the nozzle 44 in a fixed orientation relative to the housing 12. Alternatively, the concave surfaces of the ball cups 40, 42 may be designed such that the O-rings 60 and annular grooves 58 are not required. As a non-limiting example of such an alternative construction, the concave surfaces 56 of the ball cups 40, 42 may be defined with or without an insert of polymeric, metal or other material, while performing the same functions and operations of the O-rings, as further discussed below.

Provided between the inner ball cup 40 and an inner end wall 62 of the enlarged diameter portion 36 is an additional O-ring 64. The opposing end wall 66 of the inner ball cup 40 may be provided with a groove 68 to receive and define a seat for the O-ring 64. Generally, the O-ring 64 and the groove 68 may be provided anywhere on the end wall 66, but preferably these features are concentric with the axis defined through the angle portion 34 and the enlarged diameter portion 36.

Adjacent to the annular groove 58, the ball cup 42 is provided with an outlet opening 70 through which the outlet spout 54 of the nozzle 44 extends. In conjunction with the orifice plate 48, the diameter of the outlet opening 70 defines a range of adjustment for the smaller diameter outlet spout 54. While greater or lesser amounts of adjustability are a matter of design preference, in one preferred non-limiting embodiment, the central axis 72 through the outlet spout 54 can be adjusted by 10° to all sides of an outlet axis 73 defined by the angled and enlarged diameter bores 34, 36. Thus, the outlet spout 54 may be provided with a total adjustability of 20° .

The locking ring 50 secures the cartridge 14 within the enlarged diameter bore 36. This is achieved by defining a circumferential groove 74 within the enlarged diameter bore 36 and adjacent to the exit opening 38. The locking ring 50 is a C-ring or other structure and has an effective inner diameter that is less than the outer diameter of the orifice plate 48 and has an effective outer diameter that is greater than the diameter of the groove 74. Compressing the locking ring 50, it can be moved into the groove 74 where it expands outwardly into engagement with the groove 74. Upon securement of the locking ring 50 within the circumferential groove 74, the orifice plate 48 and the remainder of the cartridge 14 are captured and retained within the enlarged diameter bore 36 of the housing 12. Notably, the axial dimensions of the components of the cartridge 14 are such that the O-ring 64 at the opposing end of the cartridge 14 operates as a biasing member and provides a biasing force on the cartridge towards the locking ring 50. This biasing force not only retains the components of the cartridge 14 together, but also establishes the preload for the desired frictional engagement between the O-rings 60 spherical body 52 of the nozzle 44, which maintains the spray angle set by the end-user of the showerhead 10. The frictional engagement is of an amount sufficient to retain the outlet spout 54 in a fixed position relative the housing 12 when discharging a spray of water therefrom, while also allowing the angle of the outlet spout 54, relative to the axis 72, to be changed by the end-user as desired.

As seen in the various figures, the exterior shape of the outlet spout 54 is also conical, decreasing in diameter in the water discharge direction of the outlet spout 54. This direction is generally downward when installed and as seen in the figures. This shape, in conjunction with the magnitude of the frictional engagement between the spherical body 52 and the O-rings 60, assists in the ligature resistance of the overall design. If an attempt is made to secure a ligature to the outlet spout 54, a downward force applied to the ligature will result in the downward force overcoming the friction force retaining the outlet spout's position, which in turn will cause the outlet spout 54 to move downward. The outlet spout 54 may then be angled as little as 22° from vertical, which would further facilitate a ligature being pulled off of the outlet spout 54 as a result of downward pressure force.

Referring again to FIGS. 4A-4E, a second embodiment of the housing 12′ is illustrated therein. In the figures, like features are commonly presented with like reference numerals in addition to a prime designation. Such commonly designated features serve the same function and purpose as discussed above, and reference thereto should be made in connection with the present figures.

Generally, the exterior shape of the housing 12′ is also conical. However, the general conical shape is a stepped progression from the plane P of the base wall 26′ to the apex 28′ and includes a frustoconical base 76 adjacent to the wall 18 with a partial conical projection 78. Between the base and projection 76, 78 is a planar step 80, which is parallel with the surface of the wall 18. As noted above, the projection 78 is a partially conical. In this regard, the projection 78 includes opposed and inwardly tapered lateral sidewalls 82 before terminating in a planar apex 28′, which is also downwardly angled relative to the planar step 80.

The showerhead 12′ of FIGS. 4A-4E is mounted to the spigot (not shown in FIGS. 4A-4E) by an insert 84. The insert 84 is provided with internal threads 24′ at one end of an internal passageway 20′, which are configured to engage external threads provided on the spigot. On its opposing end, the insert 84 is provided with a plug end 86 that is received within a receiving recess 88 defined in the housing 12′. The engagement between the plug end 86 and the recess 88 is a fluid tight engagement that may include one or more O-rings 90 to provide the seal there between. As illustrated, the O-ring 90 is provided in a groove formed in the insert, but the groove may alternatively be formed in the recess 88 of the housing.

To retain the insert 84 in the recess 88, a circumferential groove 92 formed in the insert 87 receives a set screw 94 extended through a threaded bore 96 in the projection 78 of the housing 12′. Preferably, when fully engaged, the outward end of the set screw 94 is recessed from the exterior surface of the projection and located within the bore 96.

As a person skilled in the art will really appreciate, the above description is meant as an illustration of at least one implementation of the principles of the present invention. This description is not intended to limit the scope or application of this invention since the invention is susceptible to modification, variation and change without departing from the spirit of this invention, as defined in the following claims.

I/We claim:

1. A ligature resistant showerhead comprising:
a housing, the housing having an exterior shape resistant to the attachment of a ligature, portions of the housing defining a water passageway through the housing, the passageway having an inlet end and an outlet end, the outlet end of the passageway including portions defining an enlarged diameter recess about an outlet axis; and
a water directing component received and retained in the recess of the housing, the water directing component including a nozzle having an outlet spout, the nozzle being moveable between a plurality of angular positions relative to the outlet axis and defining different spray angles of the showerhead, the water directing component further including a body in frictional engagement with a portion of the nozzle whereby the outlet spout is selectively retained in one of the plurality of angular positions by the frictional engagement and is moveable between the plurality of angular positions by a manually applied force to the nozzle.

2. The showerhead according to claim 1, further comprising a biasing member coupled to and applying a biasing force against the water directing component.

3. The showerhead according to claim 2, wherein the biasing member is positioned between the housing and the water directing component.

4. The showerhead according to claim 2, wherein the biasing member is positioned within the recess.

5. The showerhead according to claim 2, wherein the biasing member is an O-ring.

6. The showerhead according to claim 2, wherein the biasing member is located in the recess and positioned in between the housing and one of the ball cups.

7. The showerhead according to claim 6, wherein the biasing member is an O-ring.

8. The showerhead according to claim 1, wherein the friction member is an O-ring

9. The showerhead according to claim 1, wherein the water directing component includes two friction members.

10. The showerhead according to claim 9, wherein the two friction members are O-rings.

11. The showerhead according to claim 1, wherein the outlet spout is part of a moveable nozzle having a spherical body from which the outlet spout extends.

12. The showerhead according to claim 1, wherein the water directing component further includes a pair of ball cups enclosing the spherical body.

13. The showerhead according to claim 12, wherein the friction member is positioned between at least one of the ball cups and the spherical body.

14. The showerhead according to claim 1, wherein the outlet end of the passageway is oriented at an angle relative to the inlet end of the passageway.

15. The showerhead according to claim 1, wherein the housing includes a base wall oriented perpendicular to the inlet end of the passageway, the inlet end of the passageway being offset from a center of the base wall.

16. The showerhead according to claim 1, wherein the housing is conical.

17. The showerhead according to claim 1, wherein the housing tapers from a base wall to an apex, the inlet end of the passageway being located toward the base wall and the outlet end of the passage being located toward the apex.

18. The showerhead according to claim 1, wherein the housing defines a length from a base wall to an apex and progressively reduces in effective diameter over the length.

19. The showerhead according to claim 1, wherein the housing defines a length and progressively reduces in width over the length.

20. The showerhead according to claim 1, wherein the housing includes exterior surfaces extending from a base wall to a distal end, and all of the exterior surfaces of the housing having a decreasing slope in a direction proceeding from the base wall to the distal end.
